(19) United States
(12) Patent Application Publication
(10) Pub. No.: US 2010/0213330 A1
(43) Pub. Date: Aug. 26, 2010

(54) Computer Stand

(75) Inventor: Bart M. Downing, Sping, TX (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/391,606

(22) Filed: Feb. 24, 2009

(51) Int. Cl. F16M 11/04

(52) U.S. Cl. 248/176.3; 248/176.1

(57) ABSTRACT

A computer stand includes a support substrate and a number of support elements configured to selectively attach at any of a range of positions across the support substrate so as to support a computer resting on the substrate while without obstructing access to features on the computer.

### BACKGROUND

With the advent of personal portable computers, often referred to as notebook or laptop computers, users can operate their computers in virtually any location. While this convenience is generally appreciated, some users find that it is less comfortable to work on such a computer, particularly if the computer is resting on a flat surface such as a desk or table.

For example, the keyboard of a traditional desktop computer will generally have a keyboard that is angled toward the user rather than laying completely flat as does the keyboard of a laptop resting on a table. Additionally, the screen of a laptop will be further from the user's eyes if the laptop is sitting on a desk or table as compared to the monitor of a traditional desktop computer which is usually supported to sit closer to a user's eye level.

Consequently, there has been a need to increase the comfort of a user who is working on a laptop computer at a desk or table. In some instances, docking stations have been created to allow the laptop to plug into a system that provides all the comforts of a traditional desktop system. In another alternative, some have developed portable stands that support the laptop on a desk or table in a position that is more comfortable for some users.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1A-1C are illustrative views of a stand and laptop supported by the stand, according to one embodiment of principles described herein.

FIG. 2 is a diagram of an illustrative laptop, according to one embodiment of principles described herein.

FIG. 3A is a side elevational view of an illustrative stand according to one embodiment of principles described herein.

FIG. 3B is a front elevational view of the illustrative stand of FIG. 3A according to one embodiment of principles described herein.

FIG. 4A is a side elevational view of an illustrative stand, according to one embodiment of principles described herein.

FIG. 4B is a front elevational view of the stand of FIG. 4A according to one embodiment of principles described herein.

FIG. 5A is a side elevational view of the illustrative stand of FIGS. 3A and 3B with a portable computer resting on the stand, according to one embodiment of principles described herein.

FIG. 5B is a side elevational view of the stand of FIGS. 4A and 4B with a portable computer resting on the stand, according to one embodiment of principles described herein.

FIG. 6A is a frontal view of an illustrative rail, according to one embodiment of principles described herein.

FIG. 6B is a side view of an illustrative rail according to one embodiment of principles described herein.

FIG. 6C is a side view of an illustrative pin, according to one embodiment of principles described herein.

FIG. 6D is a frontal view of an illustrative support substrate according to one embodiment of principles described herein.

FIG. 7A is a side view of an illustrative pin, according to one embodiment of principles described herein.

FIG. 7B is a rear view of an illustrative rail, according to one embodiment of principles described herein.

FIG. 7C is a frontal view of an illustrative support substrate, according to one embodiment of principles described herein.

FIG. 8A is a side view of an illustrative stand and laptop, according to one embodiment of principles described herein.

FIGS. 8B-8D are perspective views of illustrative support brackets, according to one embodiment of principles described herein.

FIGS. 9A and 9B are perspective views of the illustrative support brackets shown in FIGS. 8B-8D supporting a laptop on an illustrative stand, according to one embodiment of principles described herein.

FIG. 10 is a perspective view of illustrative support tabs supporting a laptop on an illustrative stand, according to one embodiment of principles described herein.

FIG. 11 is a front view of an illustrative stand, according to one embodiment of principles described herein.

Throughout the drawings, identical reference numbers designate similar, but not necessarily identical, elements.

### DETAILED DESCRIPTION

As noted above, computer stands can provide added comfort for some users who operate a laptop or portable computer at a desk or table. However, the Applicant has noted that portable computers frequently have various ports located around the edges of the computer, including the front edge of the computer closest to the user. Consequently, when a portable computer is placed on a conventional computer stand, the user will find that access to the various ports is limited due to the design of the stand.

Often, these stands use a lip at the front edge of the stand against which the computer rests to assure that the computer will not slip off of the stand. If there are ports on the front edge of the computer facing the user, those ports will typically be inaccessible due to the lip against which the computer rests. Such ports at the front of the computer may include Universal Serial Bus (USB) ports, headphone ports, microphone ports, flash memory ports and IEEE 1394 interfaces. Functional buttons used to play media files on the computer or the like may also be blocked by this lip.

These issues are made more difficult to address because each make and model of laptop computer may have a different configuration of ports, functional buttons, etc. As a result, the user may have to abandon use of the stand or forego using the obstructed ports and functional buttons. In some cases, the user may attempt to plug cables or other peripherals into the ports and allow the weight of the computer to rest on the connected cable, device, etc. This may result in damage to either the port or the cable or device connected to the port. It may also result in the computer becoming unstably supported and slipping off the stand.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The present specification describes a light-weight, portable stand for a laptop computer. The stand supports the laptop computer when used on a desk, table or other surface. In particular, the stand is configured with adjustable members to avoid blocking access to ports on the computer, particularly the front of the computer, when the computer is resting on the stand.

Examples of the stand described herein may include some or all of the following elements, a support substrate on which the computer rests, a leg configured to support the substrate at an angle as desired by the user, a rail for retaining the computer on the angled substrate, and a number of pins configured to attach the rail to the angled substrate. The location of the pins attaching the rail to the support substrate can be selected and adjusted so as to allow for better access of any ports located on the front of the computer while still allowing the stand to securely support the computer.

As used herein and in the appended claims, the terms laptop computer and portable computer are used interchangeable to refer broadly to any type of portable computer including, but not limited to, laptop computers, notebook computers, tablet computers, palmtop computers, ultra mobile personal computers (UMPCs) personal digital assistants (PDAs) and the like.

As used herein and in the appended claims, the term “features,” with reference to features on a portable computer, refer broadly to any port, functional button or key or other actuatable element on the computer. As described herein, the disclosed stand avoids obstructing such features, particularly on a front edge, of a computer.

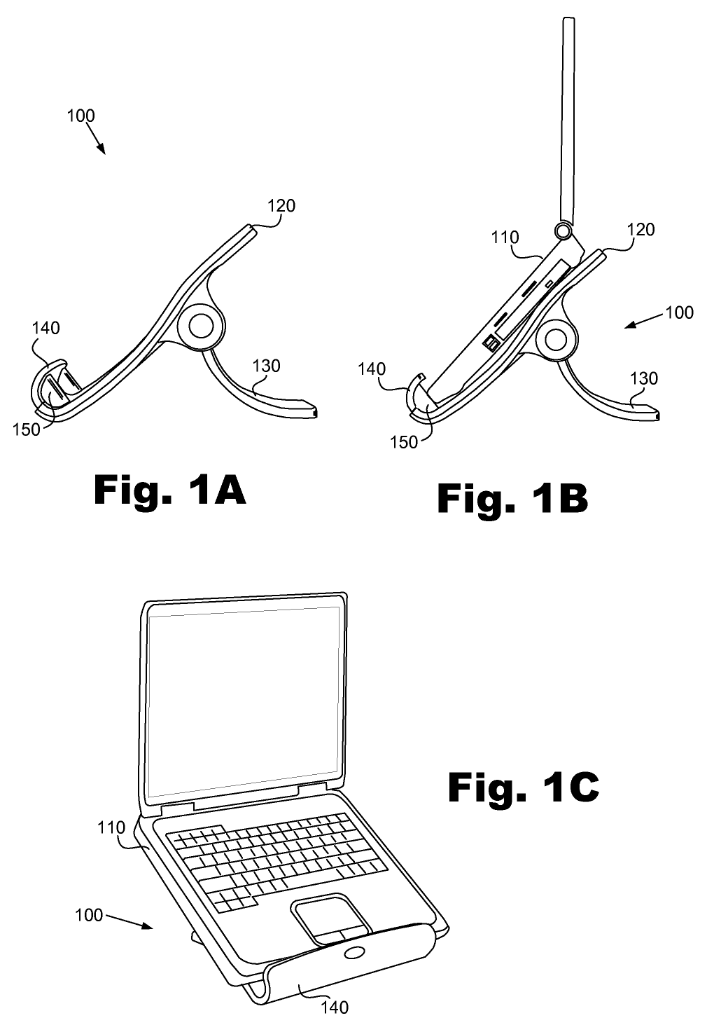

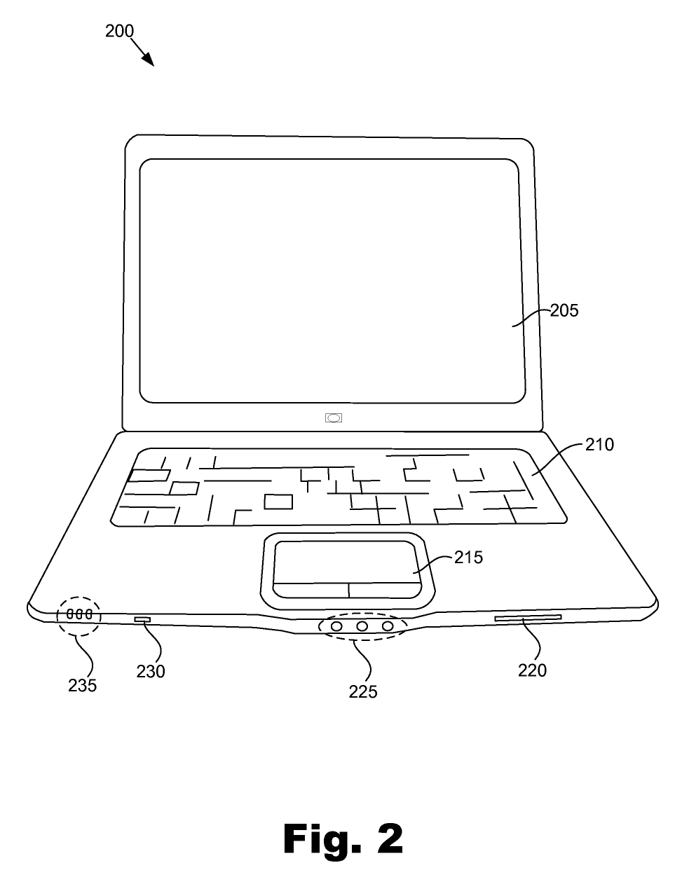

FIG. 1A is a side view of an illustrative stand (100). The stand (100) includes a support substrate (120) which is supported at an angle by a leg member (130). The lower end of the support substrate (120) ends in a curved lip (140). Compliant pads (150) are cupped inside the curved lip (140).

FIG. 1B is a side view of the illustrative stand (100) supporting a laptop (110). The laptop (110) is supported at an angle by resting against the support substrate (120). The front edge of laptop (110) rests on the two compliant pads (150) and the curved lip (140) prevents the laptop from being accidentally dislodged from the stand (100). The curved lip (140) may also provide a rest for the wrists of the laptop's user.

FIG. 1C is a perspective view of the illustrative stand (100) supporting the laptop (110). As can be seen in FIG. 1C, features which are located on the front edge of the laptop (110), as well as some features on the keyboard surface are obstructed by the curved lip (140).

FIG. 2 is a perspective view of an illustrative laptop (200) which includes a number of features on or near its front edge. As discussed above, these features may be obstructed or obscured by the lip at the bottom of a stand. The laptop (200) includes a screen (205) and a keyboard (210). On its front edge, the laptop (200) has status indicator lights (234), a USB port (230), headphone and microphone ports (225), and a card reader port (220). Additionally, the laptop (215) includes a touch pad (215) and its associated buttons which may be partially obscured by the lip (e.g., 140, FIG. 1) of a support stand.

Further, the front edge of the laptop (200) does not form a straight line, but rather has a countered surface that extends toward a user in the center portion of the laptop. Both the contour and the location/type of ports can change from between various models and makes of laptops.

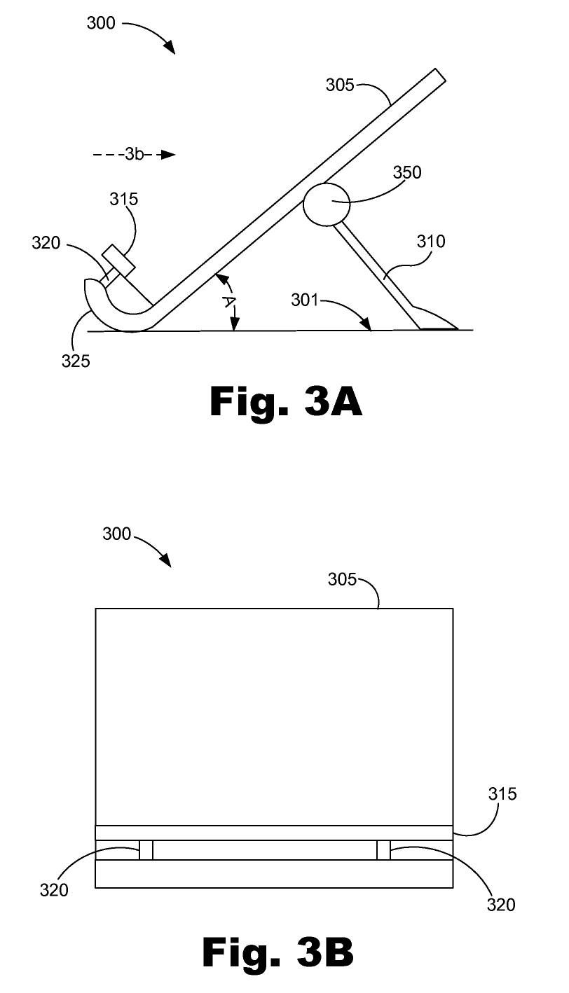

FIG. 3a illustrates an exemplary side elevational view of a lightweight, portable computer stand (300) according to principles described herein. The stand (300) includes a support substrate (305) which is supported at an angle by a leg member (310). The support substrate (305) will hold the laptop computer at an angle (A) with respect to a table, desk or other surface (301) on which the stand (300) rests, with the computer being angled toward a user.

The leg member (310) allows for support of the substrate (305) as well as adjustments to the angle of the substrate (305) depending on the user's comfort. This is accomplished by either decreasing or increasing the angle between the leg member (310) and the angled substrate (305) at a joint (350).

The lower end of the support substrate (305) is angled or turned into a shelf (325). The stand (300) also includes a rail (315) attached to the shelf (325) by a number of pins (320).

In one exemplary embodiment, the number of pins (320) connecting the rail (315) to the shelf (325) is two. As will be described in further detail below, the pins (320) can be set in various locations along the shelf (325) and rail (315) to accommodate access to the ports or functional buttons on a particular laptop computer and according to the user's needs and wants. A number of pins (320) can be locked or snapped into position to support the rail (315) away from any ports on the computer which would be placed on the stand (300).

FIG. 3B illustrates an exemplary front elevational view of the stand (300). As shown in FIG. 3B, the rail (315) is supported by a pair of pins (320) on the shelf of the support substrate (305). The number of pins (320) can be as few as two or as many as the user wishes to use. With the configuration shown in FIG. 3B, any ports or other controls located in the center of the front of a laptop computer will be accessible between the pins (320).

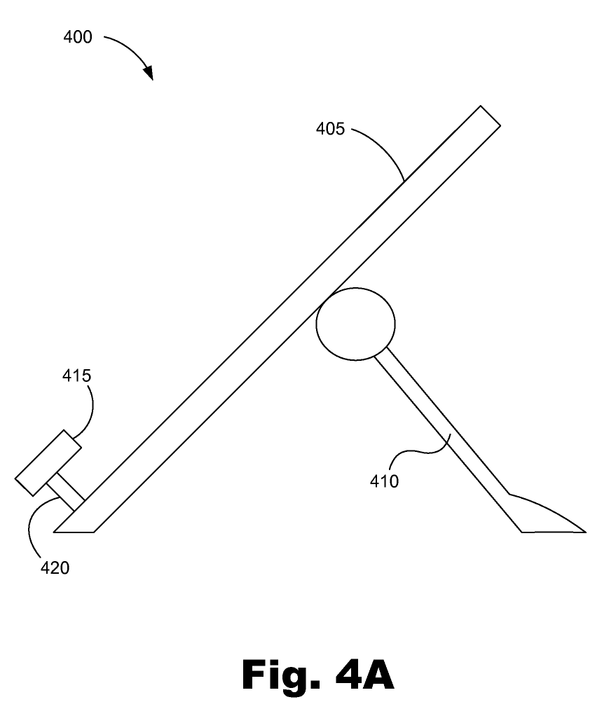

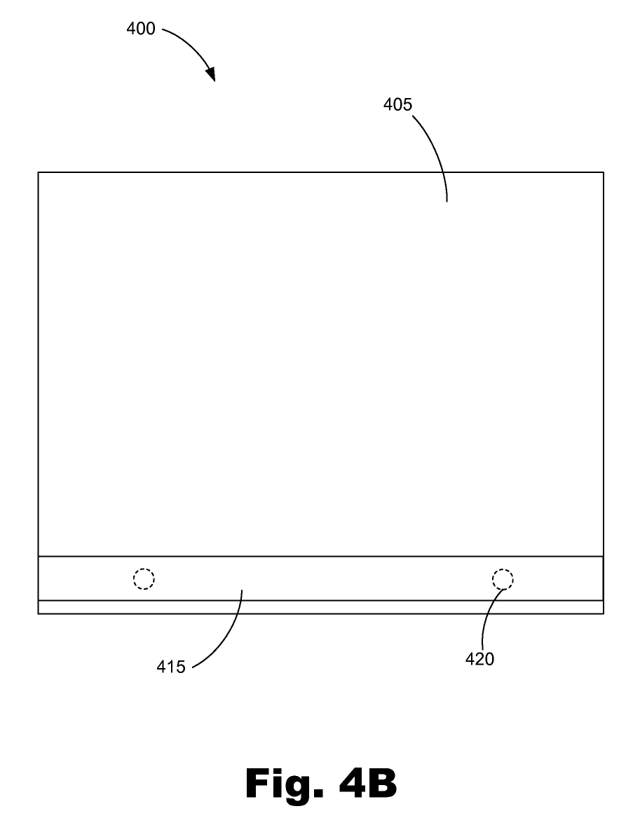

FIG. 4A illustrates an exemplary side view of another embodiment of a portable computer stand (400). As shown in FIG. 4A, the stand (400) includes a support substrate (405) which is supported at an angle by a leg member (410). The leg member (410) allows for support of the angled substrate (405) as well as adjustments to the angle of the substrate (405) depending on the user's preferences. This is accomplished by either decreasing or increasing the angle between the leg member (410) and the angled substrate (405).

The stand (400) also includes a rail (415) attached to the distal end of the support substrate (405) by a number of pins (420). In the present example, the support substrate (405) does not include a shelf, but rather terminates at its distal end in a single plane.

In this configuration, the pins (420) support a computer, which is also held in place by the rail (415) attached to the pins. With the configuration shown in FIG. 4A, any ports or other controls located in the center of the front of a laptop computer will be accessible between the pins (420).

FIG. 4B illustrates an exemplary front view of the stand (400) described above with respect to FIG. 4A. In the view shown in FIG. 4B, the support substrate (405) and the rail (415) are visible. The pins (420) supporting the rail (420) are not visible, being located beneath the rail, but are shown as dashed circles.

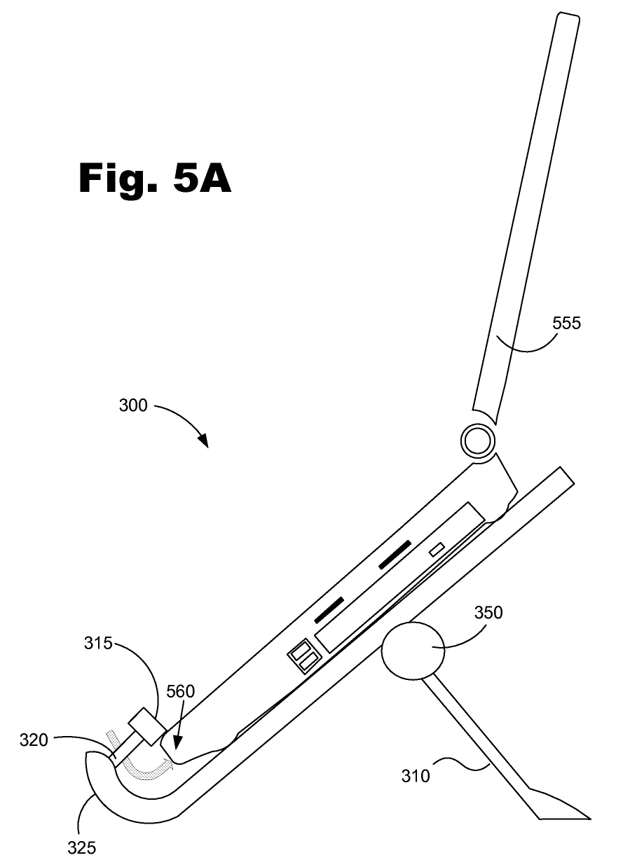

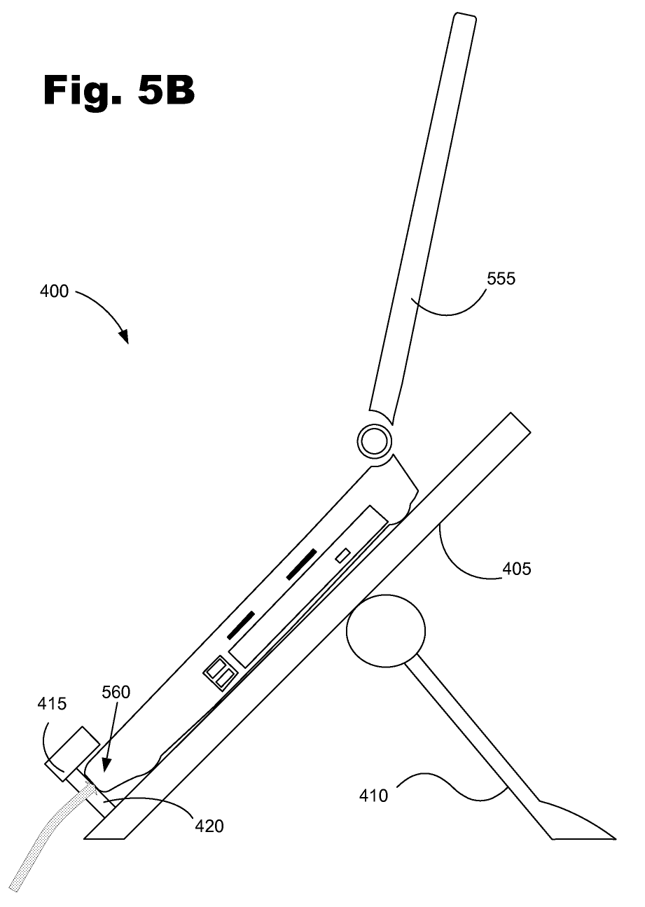

FIG. 5A illustrates an exemplary side view of the stand of FIGS. 3A and 3B with a portable or laptop computer (555) being in place on the stand (300). In FIG. 5A, the laptop (555) rests on the rail (315). The shaded arrow in FIG. 5A illustrates access between the pins (320) to a feature (560), such as a port or control button. The feature (560) is located along the front edge of the computer (555) where it would be obscured if the front of the computer were resting against a solid shelf.

FIG. 5B illustrates an exemplary side view of the stand of FIGS. 4A and 4B with a portable or laptop computer (555) being in place on the stand (400). In FIG. 5B, the laptop (555) rests behind the rail (415) and on the pins (420) that support the rail (415). The shaded arrow in FIG. 5B illustrates access between the pins (420) to a feature (560), such as a port or control button. The feature (560) is located along the front edge of the computer (555) where it would be obscured if the front of the computer were resting against a solid shelf.

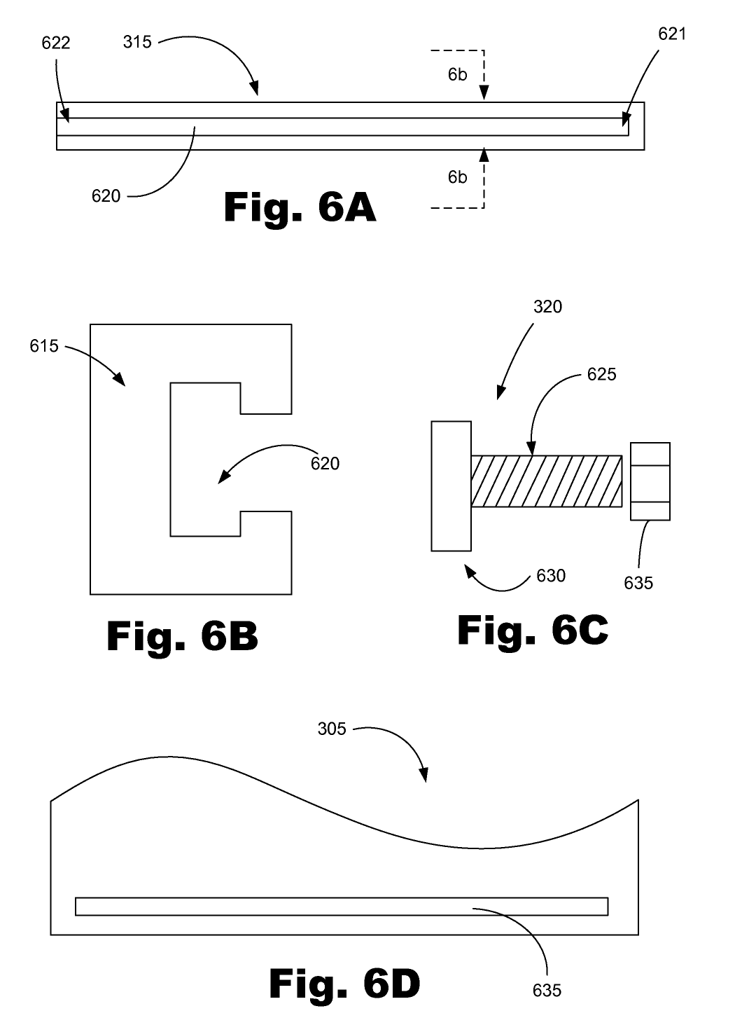

FIG. 6A illustrates an exemplary back view of a rail (315). The surface of the rail (315) shown in FIG. 6A is that to which the pins (320) are connected and which faces the support substrate (305) when the stand is assembled.

As shown in FIG. 6A, the back of the rail (315) has a lateral hollow track (620). This track (620) accommodates the heads of any number of pins (320) being used to secure the rail (315) to the support substrate. Because of the continuous track (620), pins connected to the support substrate can be located at any point along the rail (315). Engagement of the track (620) and pins will be described in further detail below.

FIG. 6B illustrates an exemplary side view of the rail (315). As shown in FIG. 6B, the track (620) in the rail (315) has a c-shaped cross-section so as to receive a number of pins (320).

FIG. 6C illustrates an exemplary side view of a pin (320) as described herein. As shown in FIG. 6C, the pin (320) has a head (630) that extends over a shaft (625). As shown in FIG. 6C, the shaft (625) may be threaded.

Referring to both FIGS. 6B and 6C, once the pins (320) are secured to the support substrate, as described in more detail below, the rail (315) can be slid laterally over the pins (320) such that the heads (630) of the pins are received in the c-shaped track (620) with the shaft (625) extending toward the support substrate.

Referring again to FIG. 6A, in some embodiments, the track (620) may be closed at one end (621) of the rail (315) such that the track (620) engages the pins starting at the other end (622) of the rail (315).

The pin heads (630) may be sized so as to fit flush inside the rail and contact the inner walls of the cavity (620). The contact between the pin (320) and the rail (315) will prevent the pin from becoming loose while attached to the support substrate (305).

FIG. 6D illustrates an exemplary front view of the lower end of the support substrate (305). In the illustrated embodiment, the support substrate (305) has a lateral slit (635) cut therein to receive the threaded shafts (635) of any number of pins (320) passing through. With the threaded shafts (635) of the pins (320) extending through the slit (635), the pins may be secured in place by a fastener such as a nut (635, FIG. 6C) or other fastening means. Because of the continuous opening provided by the slit (635), pins may be secured at any position along the slit (635) as best suits the needs of a particular user.

If a nut (635) is used to secure the pin (320), the nut (635) will contact the sides of the slit (635) at the rear of the substrate (305) and can be tightened sufficiently to prevent lateral movement of the pin (320) in the slit (635). The nut (635) may be tightened after the rail (315) is installed to secure the rail in the place. Alternatively, the shaft (625) may have an enlarged portion just below the head (630) that will sit astride the slit (635), elevating the head (630) above the substrate (305) so that the rail (315) can be installed on the pins (320) after the nuts (635) have been tightened to prevent lateral movement of the corresponding pins (320).

In an alternative embodiment, the slit (635) may be replaced with a line of threaded holes in the support substrate. In such an embodiment, the pins (320) could be screwed directly into any of the threaded holes as best suits the needs of a particular user.

As will be appreciated by those skilled in the art, threaded pins are only one possible embodiment. Any other means of securing the pins to the support substrate may be used. For example, cotter pins may be secured in holes in the pin shafts (625).

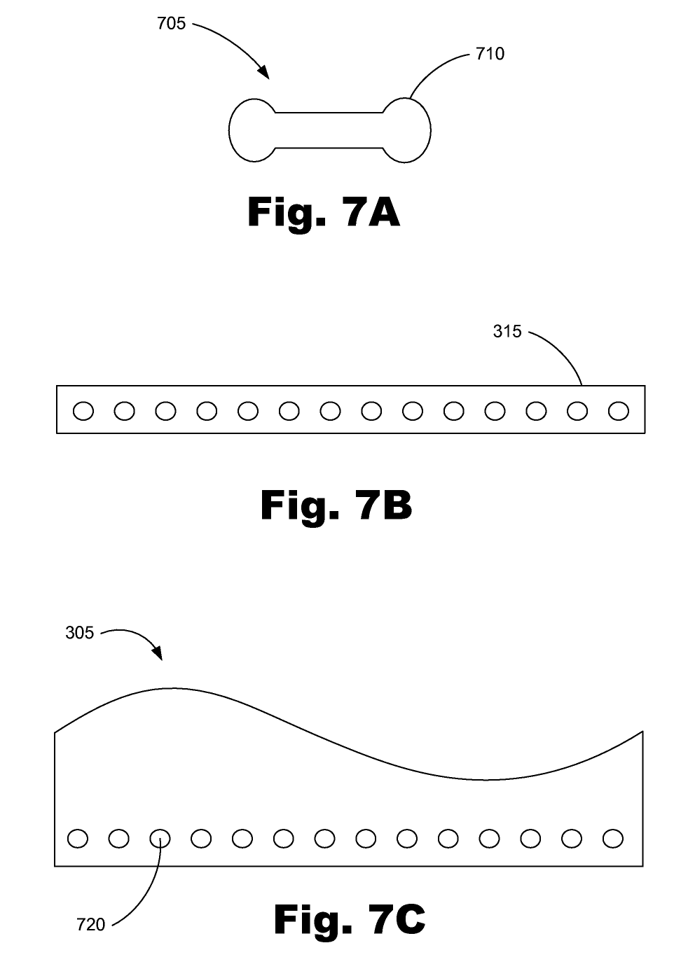

In other embodiments, the pins may form a tight interference fit with receiving holes in the support substrate like pegs. FIGS. 7A through 7C illustrate such an exemplary embodiment.

FIG. 7A illustrates an exemplary side view of a pin (705) to be used with a rail and substrate shown in FIGS. 7B and 7C, respectively. The pin (705) has bulbous ends (710) which provide a fit tight for the pin (705) in corresponding receiving holes in the rail of FIG. 7B and the support substrate of FIG. 7C. As will be appreciated by those in the art, the pin (705) may have only one bulbous end as best suits a particular application.

As shown in FIG. 7B, the backside of the rail (315) includes a line of receiving holes (700) into which for pins (e.g., 705 in FIG. 7A) can be inserted. With the continuous line of holes (700) in the rail (315), pins (700) can be connected to the rail (315) at various points along the length of the rail (315) where a receiving hole (700) is provided. This allows for the pins (705) to be positioned where there will be minimal interference with ports or function buttons on a portable computer being supported.

FIG. 7C illustrates an exemplary front view of the lower end of a support substrate (305). Close to its proximal end, the support substrate (305) has a number of receiving holes (720) configured to receive an end of the pins (705) that connect to the rail (715).

After a number of pins (705 in FIG. 7A) have been pushed into the holes (720) at specific locations as desired by the user, the rail (315 in FIG. 7B) may be attached to the support substrate by pushing free ends of the pins (705 in FIG. 7C) into the holes (700 in FIG. 7B) located in the rail (315 in FIG. 7B). Alternatively, pins (705 in FIG. 7A) may be inserted as desired into the holes (700 in FIG. 7B) in the rail (315 in FIG. 7B). Then, the assembled rail (315 in FIG. 7B) and pins (705 in FIG. 7A) can be attached to the support substrate (705 in FIG. 7C) by inserting the free end of the pins (705 in FIG. 7A) into the holes (720 in FIG. 7C) of the support substrate (705 in FIG. 7C). In either case, the rail is snapped in place on the support substrate.

In some embodiments, the pins (700 in FIG. 7A) can be used in the holes (720 in FIG. 7C) of the substrate (305 in FIG. 7C) without a rail. Then, the computer being supported would rest directly on the pins (700 in FIG. 7A) extending from the substrate (305 in FIG. 7C), with the pins being positioned to avoid obstructing any ports or function buttons on the computer.

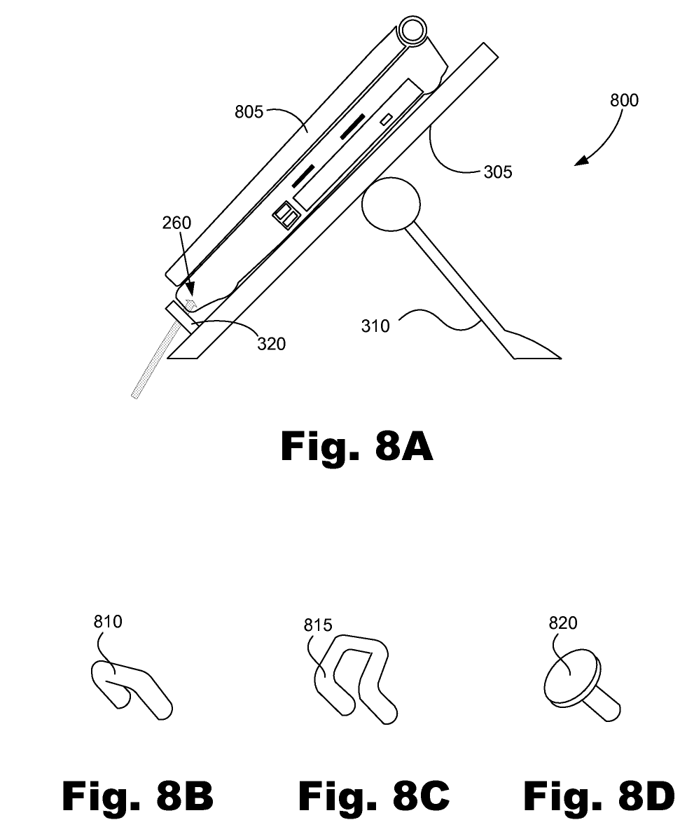

In FIG. 8A, an illustrative support (800) allows the computer (800) to rest on the pins (320) themselves without using a rail. Again, the shaded arrow in FIG. 8A illustrates access between the pins (320) to a feature (560).

In addition to the pin (705, FIG. 7A) illustrated in FIG. 7A, a variety of support brackets can engage a series of holes in the substrate (305). FIGS. 8B-8D illustrate a number of illustrative embodiments of support brackets. FIG. 8B shows a U-shaped bracket (810) which engages two adjacent holes in the substrate. FIG. 8C shows a bent U-shaped bracket (815) which engages two adjacent holes in the substrate (305). The bent U-shaped bracket (815) forms a lower support which engages the front of the laptop and prevents it from sliding down the substrate as well as providing a lip which prevents the laptop from falling off the support. FIG. 8D is an illustrative embodiment of a pin (820) which includes an enlarged head. These support brackets (810, 815) and pins (705, 820) can be placed in any of the holes (720, FIG. 7C) to support the laptop while providing access to the desired features.

According to one embodiment the shafts of these support brackets (810, 815) and pins (705, 820) may be coated with a compliant and/or nonslip material. This material will prevent damage to the laptop front edge and reduce the likelihood that the laptop will slip out of the desired position. In some circumstances, it may be desirable for these brackets or pins to be manufactured out a resilient material, such as plastic or plastic covered metal, such that they are slightly deformed when the laptop engages them. The brackets and/or pins would then hold the laptop in place with an additional clamping force that results from their deformation.

As discussed above, these support brackets (810, 815) and pins (705, 820) may attach to the support substrate (305) in a variety of ways, including but not limited to, interference fits, snap fits, screwed fasteners, cotter keys, clamps, clips, retaining rings, and other suitable fasteners.

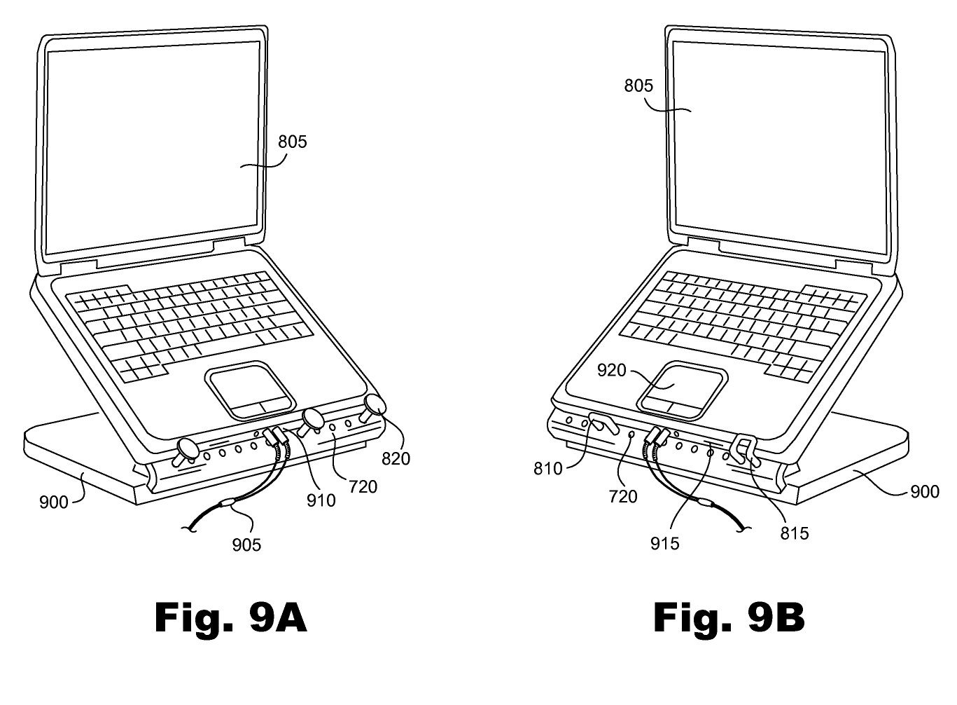

FIGS. 9A and 9B show illustrative combinations of brackets (810, 815) and pins (705, 820) used to support a laptop (805). In FIG. 9A, a laptop (805) is held on a support (900). Three pins (820) are selectively engaged in the line of holes (720) such that the features (910) on the front edge of the laptop (805) are accessible. Cables (905) can freely be connected to the desired ports (910).

FIG. 9B shows an illustrative embodiment in which two different types of brackets are used to support the laptop (805) on the support (900). The U-shaped bracket (810) is placed in adjacent holes on the left side of line of holes (720) in the substrate. The bent U-shaped bracket (815) is placed in adjacent holes on the right side of the line of holes (720). The combination of the two or more of various brackets and pins can be advantageous for a number of reasons. For example, the laptop is easier to remove from the U-shaped bracket (810) but the bent U-shaped bracket (815) holds the laptop more securely in place. By combining the two types of bracket, the laptop is securely held in place but is easier to remove. For example, the user may remove the laptop (after any desired disconnections are made) by grasping the laptop and slightly rotating it counterclockwise to disengage the lip on the bent U-shaped bracket (815). The laptop (805) can then be lifted clear from the support (900). Further, the user has the option of placing and using the various brackets and pins to their best advantage. Additionally, when the user purchases a new laptop, the support (900) can be reconfigured.

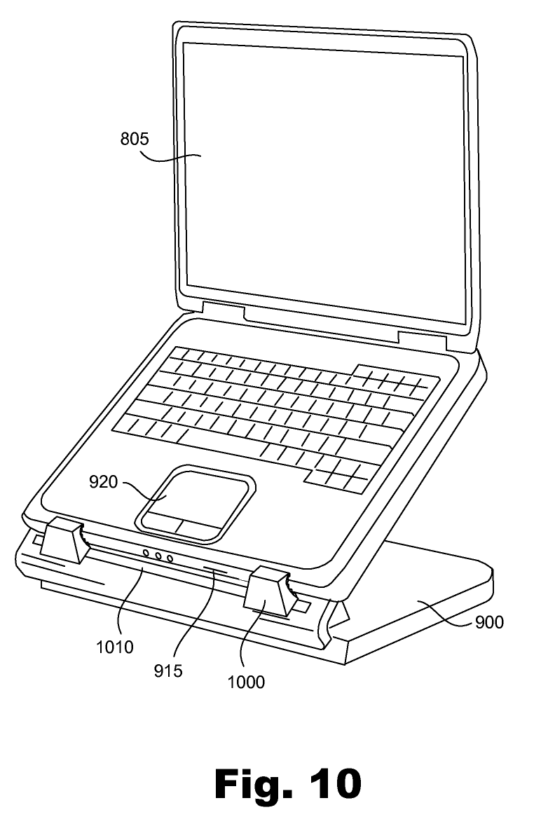

FIG. 10 shows another illustrative embodiment of the support (900). In this embodiment, tabs (1000) slide in a slot (1010). The user may position the tabs (1000) at any desirable location such that features (915) are not covered by the tabs (1000) and the laptop (805) is securely held in place. According to one illustrative embodiment, the tabs (1000) may lock into place to prevent their accidental motion. The user can disengage the tabs in a number of ways, including pushing the tabs (1000) upward or compressing the sides of the tabs to disengage the locking mechanism. The user then slides the tab (1000) along the slot (1010) to the desired locations and re-engages the locking mechanism.

In one illustrative embodiment, the surface of the tabs (1000) which engage the front of the laptop (805) may be concave or have an integral lip which holds the laptop securely in place on the support (900). This surface may also be covered with a variety of materials including a textured rubber material to additionally prevent slippage and provide cushioning for the laptop (805).

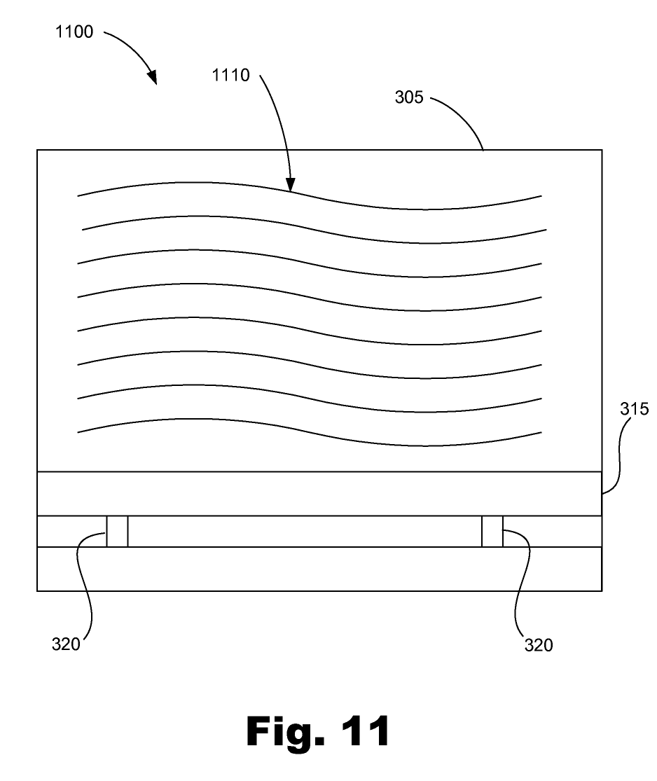

FIG. 11 illustrates another potential feature of embodiments of a computer stand (1100) as described herein. As shown in FIG. 11, the support substrate (305) may include surface features (1110) that increase the frictional forces between the support substrate (305) and a portable computer. For example, surface features (1110) may be strips of rubber disposed on or set into the support substrate (305). As shown in FIG. 11, the strips may have a wavy shape so as to apply friction at a variety of angles to a computer resting thereon.

The surface features (1110) will help prevent a laptop computer from sliding down the support substrate (305). Consequently, the rail (315) and pins (320) will not need to bear the entire weight of the computer.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A computer stand, comprising:
a support substrate;
a number of support elements configured to selectively attach at any of a range of positions across said support substrate so as to support a computer resting on said substrate without obstructing access to features on said computer.

2. The stand of claim 1, further comprising a rail supported by said support elements to help retain a portable computer on the support substrate

3. The stand of claim 2, wherein said rail comprises a track sized to engage heads of said support elements.

4. The stand of claim 1, further comprising a leg configured to support the substrate at any of a range of angles.

5. The stand of claim 1, wherein said support substrate comprises a slit for receiving an end of said support elements at any of a range of positions along said slit.

6. The stand of claim 5, wherein said support elements comprise threads, with a nut being threaded on each support element to secure the support element in the slit.

7. The stand of claim 1, wherein said support substrate comprises a line of holes for receiving ends of said support elements at any of a range of positions along said line.

8. The stand of claim 7, wherein each of said support elements comprises a bulbous end for engaging an interior of a said hole in said line of holes.

9. The stand of claim 7, wherein a said support element engages two adjacent holes in said line of holes.

10. The stand of claim 1, wherein said support substrate comprises surface feature that increase friction between the support substrate and a portable computer resting on said stand, wherein said surface features comprise rubber strips.

11. The stand of claim 10, wherein said rubber strips have a wavy shape.

12. A computer stand assembly, comprising:
a support substrate;
a number of support elements configured to selectively attach at any of a range of positions across said support substrate; and
a portable computer resting on said support substrate and abutting said support elements;
wherein said support elements are located across said support substrate so as to provide access to features on an edge of said computer abutting said support elements.

13. A stand for a portable computer, comprising:
a support substrate;
a rail attached to said support substrate by a number of support elements so as to retain the portable computer on the support substrate;
wherein said support elements are selectively locatable at any of a range of positions with respect to said rail and support substrate so as to allow for selective spacing between said support elements that provides access to features on said portable computer when disposed on said stand.

14. The stand of claim 13, further comprising a leg configured to support the substrate at any of a range of angles.

15. The stand of claim 13, wherein said support substrate comprises a slit for receiving an end of said support elements at any of a range of positions along said slit.

16. The stand of claim 15, wherein said support elements comprise threads, with a nut being threaded on each support element to secure the support element in the slit.

17. The stand of claim 13, wherein said support substrate comprises a line of holes for receiving ends of said support elements at any of a range of positions along said line.

18. The stand of claim 17, wherein each of said support elements comprises a bulbous end for engaging an interior of a said hole in said line of holes.

19. The stand of claim 13, wherein said rail comprises a track sized to engage heads of said support elements.

20. The stand of claim 13, wherein said support substrate comprises surface feature that increase friction between the support substrate and a portable computer resting on said stand.
